(19) United States
(12) Patent Application Publication
(10) Pub. No.: US 2015/0054181 A1
(43) Pub. Date: Feb. 26, 2015

(54) ADJUSTABLE MISTING SYSTEM FOR A FAN

(71) Applicant: Sunbeam Products, Inc., Boca Raton, FL (US)

(72) Inventors: Jeffrey D. Martin, Lake Worth, FL (US); Rahim Khan, North Point (HK)

(73) Assignee: SUNBEAM PRODUCTS, INC., Boca Raon, FL (US)

(21) Appl. No.: 14/465,897

(22) Filed: Aug. 22, 2014

Related U.S. Application Data
(60) Provisional application No. 61/868,834, filed on Aug. 22, 2013.

(51) Int. Cl. F24F 6/14; B01F 3/04

(52) U.S. Cl. CPC F24F 6/14; B01F 3/04049
USPC 261/28

(57) ABSTRACT

A misting fan including an electric motor and a fan connected to the electric motor. A protective grill surrounds the fan, and includes a front grill portion and a rear grill portion. A plurality of nozzles are positioned of the front grill portion of the protective grill. A fluid manifold is positioned on the front grill portion and includes a fluid inlet and a plurality of fluid outlets, wherein one each of the fluid outlets is in fluid communication with one each of the nozzles. A mist selector is connected to the fluid manifold, where the mist selector is actuatable to select a number of nozzles to be used to produce water mist

### CROSS-REFERENCE TO RELATED APPLICATION

The present application claims priority to U.S. Provisional Application No. 61/868,834, entitled Adjustable Misting System for Fan, filed on Aug. 22, 2013, the contents of which are herein incorporated by reference in its entirety.

### FIELD OF THE INVENTION

The invention relates to misting fans which produce a water mist for cooling purposes, and more particularly an adjustable misting fan.

### BACKGROUND OF THE INVENTION

The cooling effect provided by the evaporation of a water mist or small particles of airborne water has been used to cool humans and animals for many years. Water misters have been used in conjunction with fans or air blowers to specifically direct water bearing airflows toward the area to be cooled, and such devices are widely used to cool patios, decks and large open areas occupied by humans, and misters are also employed at athletic events to provide a cooling environment for the participants.

### SUMMARY OF THE INVENTION

A misting fan including an electric motor and a fan connected to the electric motor. A protective grill surrounds the fan, and includes a front grill portion and a rear grill portion. A plurality of nozzles are positioned of the front grill portion of the protective grill. An adjustable fluid manifold is positioned on the front grill portion and includes a fluid inlet and an plurality of fluid outlets, wherein one each of the fluid outlets is in fluid communication with one each of the nozzles. A mist selector is connected to the adjustable fluid manifold, where the mist selector is rotatable to select a number of nozzles to be used to produce a water mist.

In use, the electric motor is energized to rotate the fan, causing air to flow through the protective grill, traveling from the rear grill portion out through the front grill portion. To select the number of nozzles, the user rotates the mist selector to the number of nozzles to be used to dispense the water mist. The user can then turn on the water supply, adjusting the water pressure. The water flow through the adjustable manifold to the selected nozzles, being dispensed as a water mist. As the water mist is dispensed from the selected nozzles, the spray pattern is projected into the airflow from the front grill portion to provide the desired evaporative cooling. If during the operation of the misting fan, the user desires to adjust the number of nozzles in use, the user can use the mist selector to change the nozzles in use.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a front isometric view of the misting fan of the present application;

FIG. 2 depicts a rear isometric view of the misting fan of FIG. 1;

FIG. 3 depicts a rear isometric view of the front housing of the misting fan of FIG. 1;

FIG. 4 depicts a front isometric view of the mist selector of the misting fan of FIG. 1;

FIG. 5 depicts a rear isometric view of the mist selector of the misting fan of FIG. 1;

FIG. 6 depicts a front isometric view of the adjustable manifold of the misting fan of FIG. 1;

FIG. 7 depicts a front isometric sectional view of the adjustable manifold of FIG. 6; and

FIG. 8 depicts a rear isometric view of the adjustable manifold of the misting fan of FIG. 1.

### DETAILED DESCRIPTION OF THE INVENTION

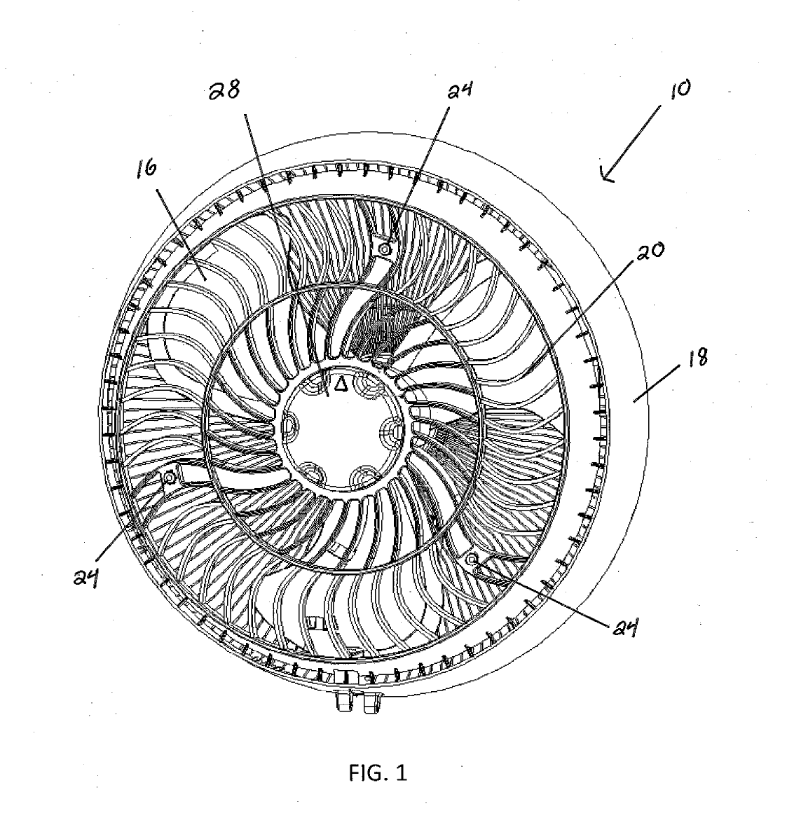

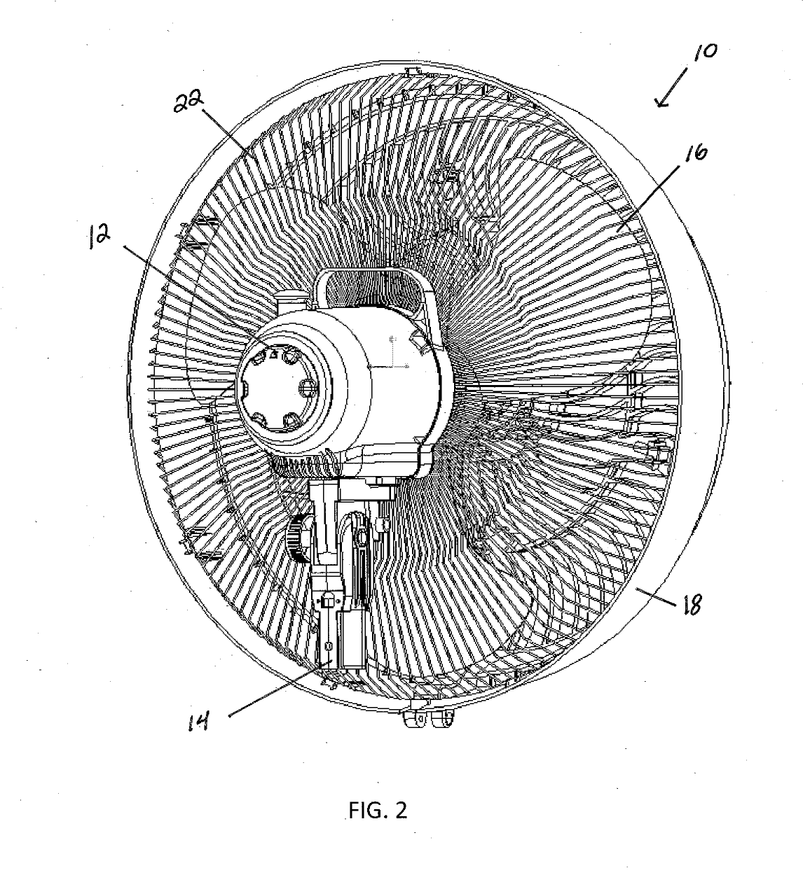

Referring now to the drawing figures in which like reference designators refer to like elements, there is shown in FIGS. 1 and 2 an exemplary misting fan 10 of the present disclosure. The misting fan 10 includes an electric motor 12 mounted to an the upper end of a pedestal 14 supported upon a base (not shown). The motor 12 includes a shaft upon on which the fan blades 16 are mounted. The fan blades 16 are enshrouded within a protective grill 18 consisting of a front grill portion 20 and a rear grill portion 22.

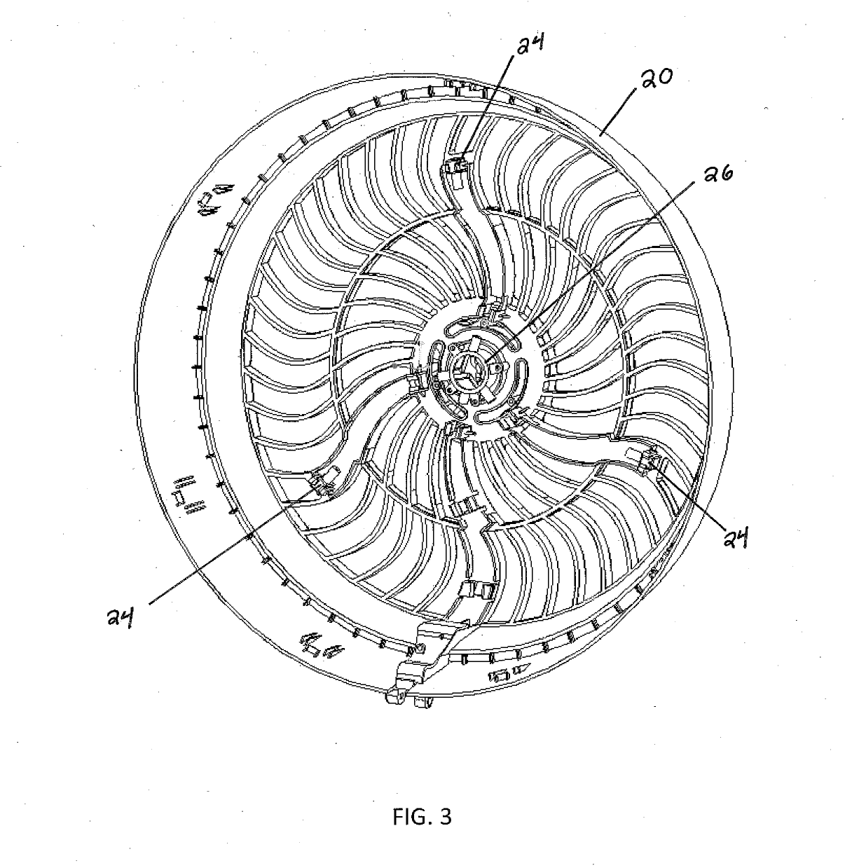

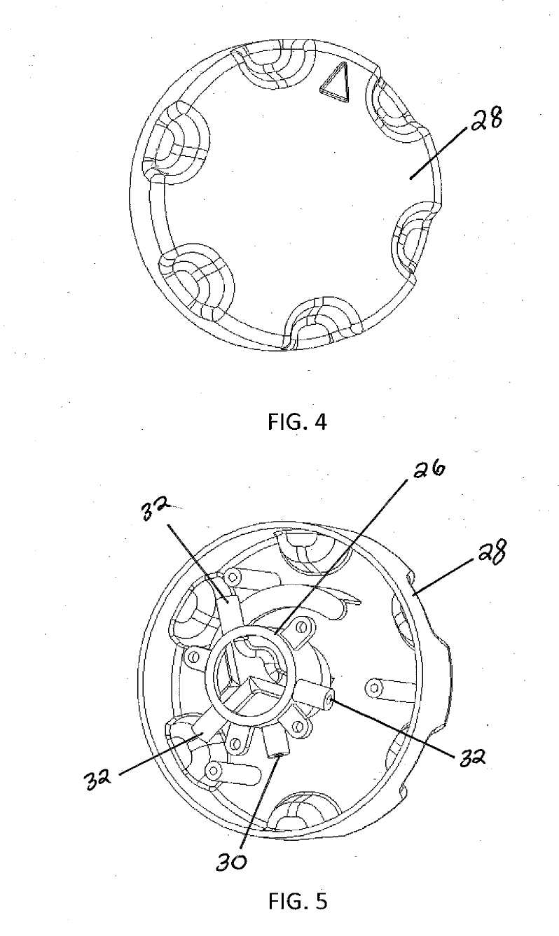

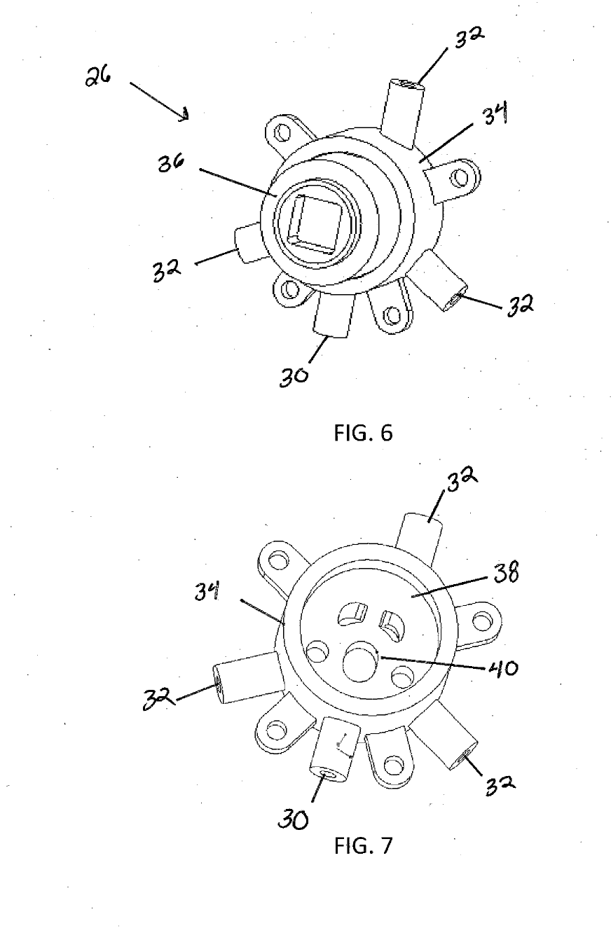

Referring also to FIGS. 3 and 5, the front grill portion 20 include a plurality of water misting nozzles 24, each in fluid communication with a fluid manifold 26. The watering misting nozzles 24 are individually affixed, at radially spaced apart intervals, to the front grill portion 20. Alternatively, the misting nozzle 24 can be integrally formed within the front gill portion 29 at the radially spaced apart interval.

It is also contemplated, though not shown, that the misting nozzles 24 can be positioned in spaced apart intervals on a side portion of the protective grill 18, and/or on the rear grill portion 22, each of which are in fluid communication with the fluid manifold 26.

The fluid manifold 26 includes a fluid inlet 30 which is in fluid communication with a water supply. The fluid inlet 30 can be connected to the water supply with a hose or tubing. The fluid manifold 26 further includes a plurality of fluid outlets 32. Each of the fluid outlets 32 is in fluid communication with a misting nozzle 24. The fluid outlets 32 can be connected to the misting nozzles 24 with a flexible or rigid tubing or piping.

The fluid manifold 26 is selectably adjustable, such the number of misting nozzles 24 used to dispense the water mist at any given time can be selected by a user. To this end, a mist selector 28 is positioned in engagement with the fluid manifold 26. The mist selector 28 can be utilized to select the number of misting nozzles 24 used to dispense the water mist. In an embodiment, the mist selector 28 is rotatably positioned in the center of the front grill portion 20, engaging the adjustable manifold 26. The mist selector 28 can be rotated to select the number of nozzles 24 used to dispense the water mist. For example, 1, 2, or 3 nozzles can be used to dispense the water mist.

In the figures three nozzles 24 are depicted on the front grill portion 20. However, it is contemplated that that the front grill portion 20 can include any number of nozzle 24, including 2, 3, 4, 5 . . . misting nozzles 24.

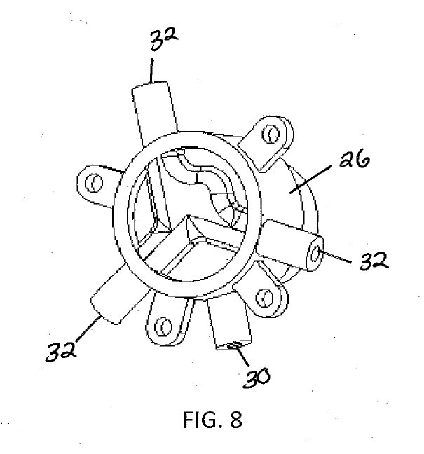

Referring to FIGS. 7-8, the fluid manifold 26 is provide in more detail. The fluid manifold includes a body portion 34 the fluid inlet 30 which is in fluid communication with a water supply. The fluid inlet 30 can be connected to the water supply with a hose or tubing. The fluid manifold 26 further includes the plurality of fluid outlets 32. Each of the fluid outlets 32 is in fluid communication with a misting nozzle 24. The fluid outlets 32 can be connected to the misting nozzles 24 with a flexible or rigid tubing or piping.

The fluid manifold 26 further includes a rotatable portion 36, rotatably connected to the body portion 34, covering a selector plate 38. The selector plate 38 include a plurality orifices 40, which can be selectively opened and closed by a rotation of the rotatable portion 36 with respect to the body portion 34, such that a fluid path can be open and closed between the fluid intel 30 and the fluid outlets 32. For example, in a first position a fluid path is open between the fluid inlet 30 and a single fluid outlet 32; in a second position a fluid path is open between the fluid inlet 30 and two fluid outlets 32; and in a third position a fluid path is open between the fluid inlet 30 and a three fluid outlets 32.

It is also contemplated the orifices 40 can be position, such that a user can select the combination, or position, of the fluid outlets 32. In this manner, a user can select which misting nozzles 24 are to be utilized.

The mist selector 28 is operably connect to the rotatable portion 36 of the fluid manifold 26, such that a rotation of the mist selector 28 is used to select the number of misting nozzle 24 to be used to dispense the water mist.

The fluid manifold 26 described herein is only exemplary in nature, and it is contemplate that alternative know or unknown fluid manifolds which allow for the selection of the number and/or position of the fluid outlets 32 can be utilized.

In the figures the fluid manifold 26 and mist selector 28 are depicted and described as being centrally positioned on the front grill portion 20. However, it is contemplated that that the fluid manifold 26 and mist selector 28 can be positioned on another portion of the fan 10, as long the fluid manifold 26 is in fluid communication with the nozzles 24.

In use, the motor 12 is energized to rotate the fan blades 16, causing air to flow through the protective grill 18, traveling from the rear grill portion 22 out through the front grill portion 20. To select the number of misting nozzles 24, the user rotates the mist selector 28 to the number of misting nozzles 24 to be used to dispense the water mist. The user can then turn on the water supply, adjusting the water pressure. The water flow through the fluid manifold 26 to the selected misting nozzles 24, being dispensed as a water mist. As the water mist is dispensed from the selected nozzles 24, the spray pattern is projected into the airflow from the front grill portion 20 to provide the desired evaporative cooling.

If during the operation of the misting fan 10, the user desires to adjust the number of nozzles 24 in use, the user can use the mist selector 28 to change the number of misting nozzles 24.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A misting fan comprising:
a protective grill;
a plurality of nozzles positioned on the protective grill;
a selectable fluid manifold including a fluid inlet and an plurality of fluid outlets, wherein one each of the fluid outlets is in fluid communication with one each of the nozzles; and
a mist selector connected to the fluid manifold, wherein the mist selector is utilized to select a number of nozzles to be used to produce a water mist.

2. A misting fan as set forth in claim 1, further comprising:
an electric motor; and
a fan connected to the electric motor, wherein the protective grill surrounds the fan.

3. A misting fan as set forth in claim 1, wherein the nozzles are radially position about the protective grill.

4. A misting fan as set forth in claim 1, wherein the protective grill includes a front grill portion and a rear grill portion, the plurality of nozzles being positioned of the front grill portion of the protective grill.

5. A misting fan as set forth in claim 4, wherein the nozzles are radially position about the front grill portion of the protective grill.

6. A misting fan comprising:
an electric motor;
a fan connected to the electric motor;
a protective grill surrounding the fan, and including a front grill portion and a rear grill portion;
a plurality of nozzles positioned on the protective grill;
a fluid manifold including a fluid inlet and an plurality of fluid outlets, wherein one each of the fluid outlets is in fluid communication with one each of the nozzles; and
a mist selector connected to the fluid manifold, wherein the mist selector is rotatable to select a number of nozzles to be used to produce a water mist.

7. A misting fan as set forth in claim 6, wherein the nozzles are radially position about the protective grill.

8. A misting fan as set forth in claim 6, wherein the nozzles are radially position about the front portion of the protective grill.

9. A misting fan as set forth in claim 6, wherein the nozzles are radially position about the rear portion of the protective grill.

10. A misting fan as set forth in claim 6, wherein the nozzles are radially position about a side portion of the protective grill.
